(19) United States
(12) Patent Application Publication
(10) Pub. No.: US 2006/0189348 A1
(43) Pub. Date: Aug. 24, 2006

(54) Systems and methods for automatic synchronization of cellular telephones

(75) Inventors: Lou J. Montulli, Reno, NV (US); James H. Clark, Rodwood City, CA (US); Jeffrey N. Whitehead, San Jose, CA (US); Jason F. Harrison, San Jose, CA (US); Aleksander K. Totic, San Francisco, CA (US); Garrett A. Blythe, Cupertino, CA (US)

Correspondence Address: TRAN & ASSOCIATES, 6768 MEADOW VISTA CT., SAN JOSE, CA, 95135, US

(73) Assignee: Memory Matrix, Inc.

(21) Appl. No.: 11/064,229

(22) Filed: Feb. 23, 2005

(51) Int. Cl. H04M 1/00

(52) U.S. Cl. 455/556.1; 348/371; 455/41.2

(57) ABSTRACT

Systems and methods are disclosed for communicating image data between a first cell phone and a remote processor by capturing image data using a first cell phone camera; connecting with the remote processor; and synchronizing images stored in the first cell phone with images stored in a data storage device coupled to the remote processor.

### BACKGROUND

The present invention relates to synchronization of data between cellular devices.

Computers are becoming increasingly powerful, lightweight, and portable. The computing power of computers that once filled entire rooms is now residing on a desktop. Laptop, notebook, and sub-notebook computers are virtually as powerful as their desktop counterparts. Even smaller hand-held computers are now capable of computing tasks that required much larger machines a few short years ago.

As a part of this trend, computerized personal organizers are becoming increasingly popular with a large segment of the population. Computerized personal organizers tend to be small, lightweight, relatively inexpensive, and can perform such functions as keeping a calendar, an address book, a to-do list, etc. For example, people use computers and handheld devices to maintain information that includes, for example, calendar and personal information manager (“PIM”) data, in addition to information contained in files such as word processing documents. Examples of a pen-based handheld system include the Newton pen-based computer from Apple Computer, Inc., the Palm handheld from Palm Computing, Inc. and the Windows/CE handheld from various manufacturers such as HP/Compaq and Casio, among others. More recently, cellular telephones have added PIM functionality as well as picture capture and sharing capability.

To address file synchronization issues, U.S. Pat. No. 5,845,282 discloses a method and apparatus for selecting and retrieving computer data files from a remote computer includes an automatic file translation mechanism. In one embodiment, the data being retrieved and the file translation mechanism are located on the same computer. The method of the invention includes establishing a data transfer link with the remote computer, displaying the files available for retrieval from the remote computer, selecting a file to be transferred, and translating the file prior to transfer. In one embodiment, the apparatus includes a pen-based computer and the remote computer is a desktop computer.

U.S. Pat. No, 6,000,000 discloses an extendible file synchronization system for sharing information between a handheld computer system and a personal computer system. The synchronization system is activated by a single button press. The synchronization system proceeds to synchronize data for several different applications that run on the handheld computer system and the personal computer system. If the user gets a new application for the handheld computer system and the personal computer system, then a new library of code is added for synchronizing the databases associate with the new application. The synchronization system automatically recognizes the new library of code and uses it during the next synchronization.

Many cell phones operate as stand alone units wherein the user enters all the information into the cell phone and the information is retrieved out of the cell phone alone. Other cell phones operate in conjunction with personal computer systems such that the cell phones and the PCs can transfer data back and forth when the cell phones are synchronized with the PCs.

U.S. Pat. No. 5,491,507 discloses a telephone which permits a user to transmit and receive pictures and speech with a casing held in one hand. A speaker is arranged at the upper end part of the front of the casing which is thin and vertically long, while a microphone is arranged at the lower end part thereof. A display panel and a control panel are interposed between the speaker and the microphone. A camera is mounted on the casing so as to be capable of altering its angle. The speaker is detachably mounted, and it is usable as an earphone when detached. The user's movements are not hampered during the transmission and reception, and the equipment can assume various communication or service attitudes conforming to the contents of information for the communications.

FIG. 1 shows an exemplary cell phone with a camera for taking pictures or videos. As mentioned in the '507 patent, the phone 1 is mainly constructed of the body 2 thereof which is thin and flat and which is in a vertically long shape, a camera 3 which is turnably mounted on the right side surface of the body 2, an ear pad 4 which is foldably mounted on the upper part of the front of the body 2, a speaker 6 which is arranged at the central part of the ear pad 4, an antenna 21 which is mounted on the right side of the top surface of the body 2, and a battery assembly 9 which is detachably mounted on the lower part of the rear surface of the body 2. In addition, a grip 35 (chamfered parts 35a) is formed extending from the rear surface of the handy type video telephone equipment 1 to both the side surfaces thereof. A display panel 11, a transmission/reception key 12, a termination key 13, a control panel 14, function keys 15, and a microphone 16 are arranged on the front surface of the body 2, in addition to the ear pad 4. The phone includes a processor and a memory, a communication device which includes a radio/video codec, a speaker, a display panel, a control circuit, a microphone, a battery, an antenna 21, and the camera 3. Additionally, Bluetooth and/or 802.11 transceivers are coupled to the control circuit so that the phone 1 can communicate with a WLAN.

Recently, smart phones such as AudioVox's SMT5600 run on Microsoft's Windows Mobile 2003 OS and contain built-in VGA cameras that take both still and video images. When finished with taking the photos, the user can save them to the phone or send them to friends via a multimedia message, Bluetooth, or an infrared port. In addition to Bluetooth, WiFi capable cellular phones have appeared. For example, Nokia's 9500 Communicator is a tri-band voice device with wide color screen and full keyboard, email, web and office applications, and the ability to connect to compatible company and public network via high-speed 802.11 Wireless LAN, GPRS and EDGE. With this device, the user can access the Internet without incurring cellular data charges whenever the user is within range of an 802.11 Wireless LAN.

### SUMMARY

Systems and methods are disclosed for communicating image data between a first cell phone and a remote processor by capturing image data using a first cell phone camera; connecting with the remote processor; and synchronizing images stored in the first cell phone with images stored in a data storage device coupled to the remote processor.

Implementations of the above systems and method can include one or more of the following. The synchronizing of images is performed automatically without an explicit user request. The remote processor can be a second cell phone or a server. The system can communicate over one of: a cellular protocol, an 802.11 protocol, a Bluetooth protocol. When communicating over a wireless local area network (WLAN) protocol, the system synchronizes image data only when excess WLAN bandwidth is available. In one embodiment, the WLAN has a maximum upload bandwidth, and the system determines current data transmission utilization of the WLAN; and synchronizes image data only when the current data transmission utilization of the WLAN is below the maximum upload bandwidth of the WLAN. The server can print the image data or simply archive the image data.

In another embodiment, the system automatic downloads images from a phone via Bluetooth or Wi-Fi protocol when in proximity of a home network or other device. The system enables the automatic transfer of multimedia data from a camera or cell phone when in proximity of a wireless hotspot. The system automatically senses when the multimedia device is in range of an appropriate wireless hotspot and begin a transfer of the data to an appropriate server over the network. This mechanism allows the user to take pictures or other multimedia and not have to go through an explicit export step. The data would be made available from the new server location for printing, sharing and archiving, and any other use. The portable device can be any of a number of digital appliances with Bluetooth and/or WiFi such as for example, a camera cell phone, a digital still or digital video camera, set-top box, game machine, photo appliance, and the like.

Advantages of the system may include one or more of the following. The system enables authorized cell phones to synchronize images with each other. The system frees up the memory in the camera cell phone for taking more pictures without having to swap out memory cards as in conventional systems. Another advantage is that it affords the user the ability to wireless synchronize all associated multimedia assets, such as digital photos, and/or albums that contain digital images. Thus, if a particular multimedia asset is captured, the information can be automatically shared with other cell phones. This synchronization is accomplished efficiently and automatically by, in one embodiment, transparently transferring newly captured images whenever the device detects an available wireless network.

### BRIEF DESCRIPTION OF THE DRAWINGS

FIG. 1 shows a prior art cell phone with a camera for taking pictures or videos.

FIG. 2 illustrates a first method of transferring information between cell phones.

FIG. 3 shows an exemplary user-activated image file synchronization process.

FIG. 4 shows an exemplary automatic image file synchronization process without user instruction.

FIG. 5 shows an exemplary automatic image file synchronization process between a cell phone and a server on a WLAN without user instruction.

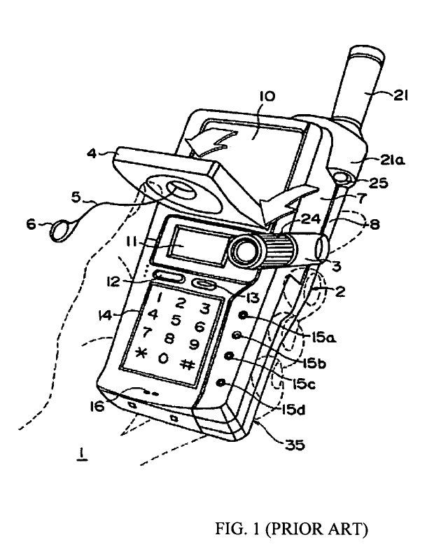

### DESCRIPTION

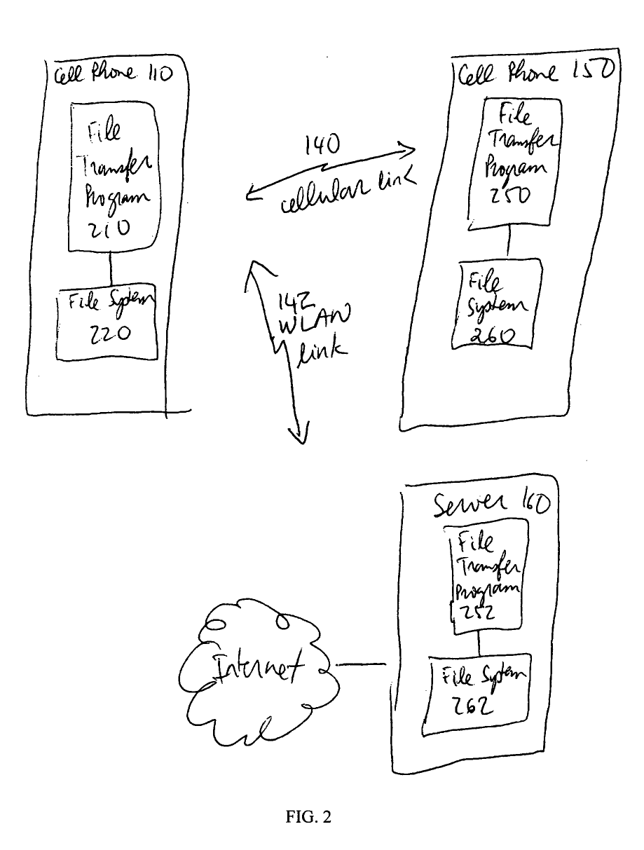

FIG. 2 illustrates a system for transferring information between cell phones 110 and 150 or other suitable portable communication systems. In the cell phone 110 in FIG. 2, a first file transfer program 210 runs on the cell phone 110 to manage file transfers from the first cell phone. The file transfer program 210 on the first cell phone 110 communicates with a local file system 220 responsible for creating and storing files such as image files. The file transfer program 210 on the first cell phone 110 communicates across a communication link 140 (such as a wired link or a wireless link over 802.11, Bluetooth, or GPRS protocols, among others) to second cell phone file transfer program 250 that runs on the second cell phone 150. The file transfer program 250 communicates with a local file system 260 on the cell phone 150. The file transfer program 210 on the first cell phone 110 also communicates over the communication link 140 to a server 160 through a server file transfer program 252 that runs on the server 160. The file transfer program 252 communicates with a local file system 262 on the server 160.

For security, in one embodiment, a link encryption for either Bluetooth or 802.11 transmissions is done as a stream cipher using 4 LFSR (linear feedback shift registers). The sum of the width of the LFSRs is 128, and the effective key length is selectable between 8 and 128 bits. Key generation and authentication is done using an 8-round SAFER+ encryption algorithm. In one embodiment, to minimize “bluesnarf attack” the cell phone's ‘visible’ mode is turned off. Additionally, a login process is performed in another embodiment where the user enters a user ID and a password before data transmission can occur.

In one embodiment, to minimize data transmission requirement a user may indicate that images may be shared one at a time or, alternatively, a plurality of images can be marked for sharing/synchronization of images and associated image data. Only selected images are then shared with other cell phones.

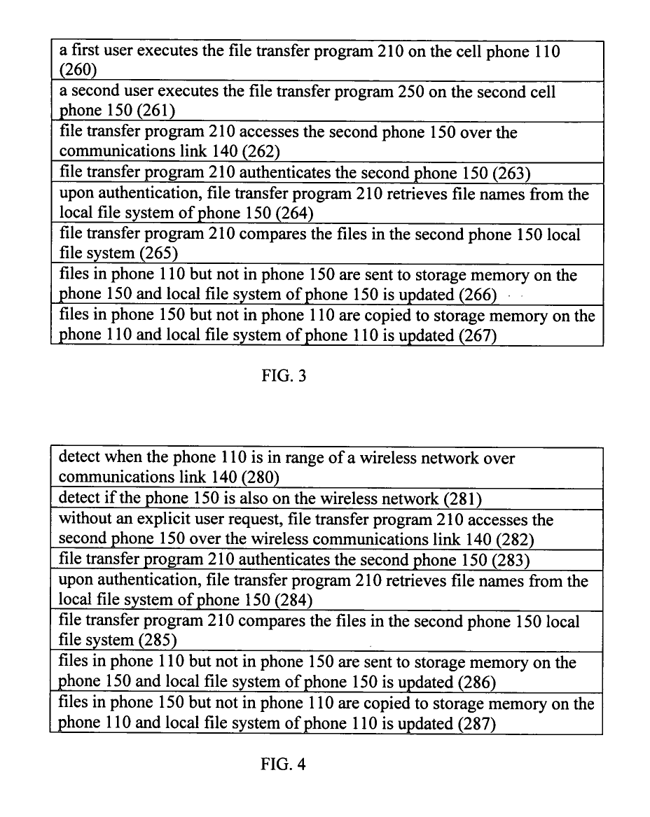

To invoke the file transfer system of FIG. 2, two methods shown in FIG. 3 and 4 can be used. FIG. 3 shows an exemplary user-activated image file synchronization process. In this process, a first user executes the file transfer program 210 on the cell phone 110 (260), and a second user executes the file transfer program 250 on the second cell phone 150 (261). The file transfer program 210 accesses the second phone 150 over the communications link 140 (262), and the file transfer program 210 authenticates the second phone 150 (263). Upon authentication, file transfer program 210 retrieves file names from the local file system of phone 150 (264) and performs a comparison to detect differences in the image files (265). Files in phone 110 but not in phone 150 are sent to storage memory on the phone 150 and local file system of phone 150 is updated (266) and files in phone 150 but not in phone 110 are copied to storage memory on the phone 110 and local file system of phone 110 is updated (267).

FIG. 4 shows an exemplary automatic image file synchronization process without user instruction. In this process, software can detect the presence of an authorized cell phone on the communications link 140 and automatically initiates an image synchronization process. The process first detects when the phone 110 is in range of a wireless network over communications link 140 (280). If so, the process also detects if the phone 150 is also on the wireless network (281). Without an explicit user request, file transfer program 210 accesses the second phone 150 over the wireless communications link 140 (282). The file transfer program 210 authenticates the second phone 150 (283). Upon authentication, file transfer program 210 retrieves file names from the local file system of phone 150 (284), and the file transfer program 210 compares the files in the second phone 150 local file system (285). Files in phone 110 but not in phone 150 are sent to storage memory on the phone 150 and local file system of phone 150 is updated (286), while files in phone 150 but not in phone 110 are copied to storage memory on the phone 110 and local file system of phone 110 is updated (287).

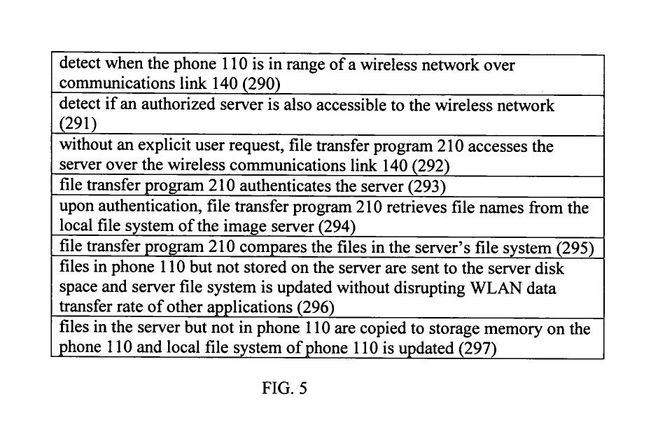

FIG. 5 shows an exemplary automatic image file synchronization process with a server. The cell phone 110 can communicate over the WLAN to a server 160 that is connected to the Internet. As would be evident to one of ordinary skill in the art, the server 160 includes a CPU, hard disk, memory, and Internet access such as a modem, network interface card, or a cable modem. Having access to the Internet, the server can transfer image data from the cell phone to a photofinisher. When within range of the WLAN, the system transfer data automatically to the storage space of the server 160 from the data storage device of the user's cell phone 110. The cell phone's WLAN transceiver then transmits the pictures over the WLAN. Alternatively, when WLAN is not present and the cell phone data storage device is almost full, the cell phone can transmit images through the cellular network (preferably using 3G) to the home-based server for storage thereon. In that case, the cell phone calls the server's modem and transmits data to the server over the POTS network.

In FIG. 5, software can detect the presence of a WLAN on the communications link 140 and automatically initiates an image synchronization process with a server connected to the WLAN. The process first detects when the phone 110 is in range of a wireless network over communications link 140 (290). If so, the process also detects if an authorized server is also accessible to the wireless network (291). Without an explicit user request, file transfer program 210 accesses the server over the wireless communications link 140 (292). The file transfer program 210 authenticates the server (293).

Upon authentication, file transfer program 210 retrieves file names from the local file system of the image server (294), and the file transfer program 210 compares the files in the server's file system (295). Files in phone 110 but not stored on the server are sent to the server disk space and server file system is updated (296), while files in the server but not in phone 110 are copied to storage memory on the phone 110 and local file system of phone 110 is updated (297).

In one embodiment, the syncing of multimedia data is achieved without disrupting existing WLAN data transfer speed. This is done by syncing the data back to the network server over the wide area wireless network only when surplus data bandwidth is available and only excess bandwidth is consumed to synchronize image data between the cell phone and the server. The system thus synchronizes image data only when excess WLAN bandwidth is available. In one embodiment, the system determines the WLAN's maximum upload bandwidth, determines current data transmission utilization of the WLAN; and synchronizes image data only when the current data transmission utilization of the WLAN is below the maximum upload bandwidth of the WLAN.

In the embodiment of FIGS. 3-5, to speed up the synchronization of images between the two cell phones, the file transfer system 210 operates only on individual files in the two computer systems such that no individual record analysis is done. For example, the file transfer programs on both cell phones can compare the dates of files on each system and transfer the more recent version from one system over to the other. This is efficient for image file transfers since it is unlikely that users would edit or otherwise alter image data files on the cell phones. In other embodiments, cell phones with matching applications can share information on a record level. For example, an address book containing names, pictures, phone numbers, and addresses of people in records can be merged at a record level.

In this disclosure and claims, the terms “transfer” and “transmit” or their derivatives are may be equivalent when transference is done through transmission. Images include image data and image data includes images. Also, in this disclosure and claims, the term “automatically” is meant to mean that something is done without the need for further input from a user.

It is to be understood that various terms employed in the description herein are interchangeable. Accordingly, the above description of the invention is illustrative and not limiting. Further modifications will be apparent to one of ordinary skill in the art in light of this disclosure.

The invention has been described in terms of specific examples which are illustrative only and are not to be construed as limiting. For example, although the buffer memory is described as high speed static random access memory (SRAM), the memory can be any suitable memory, including DRAM, EEPROMs, flash, and ferro-electric elements, for example. The invention may be implemented in digital electronic circuitry or in computer hardware, firmware, software, or in combinations of them.

Apparatus of the invention may be implemented in a computer program product tangibly embodied in a machine-readable storage device for execution by a computer processor; and method steps of the invention may be performed by a computer processor executing a program to perform functions of the invention by operating on input data and generating output. Suitable processors include, by way of example, both general and special purpose microprocessors. Storage devices suitable for tangibly embodying computer program instructions include all forms of non-volatile memory including, but not limited to: semiconductor memory devices such as EPROM, EEPROM, and flash devices; magnetic disks (fixed, floppy, and removable); other magnetic media such as tape; optical media such as CD-ROM disks; and magneto-optic devices. Any of the foregoing may be supplemented by, or incorporated in, specially-designed application-specific integrated circuits (ASICs) or suitably programmed field programmable gate arrays (FPGAs).

While the above embodiments have involved application of luminescent substances to dental structures, the invention is applicable to all non-opaque surfaces.

Although an illustrative embodiment of the present invention, and various modifications thereof, have been described in detail herein with reference to the accompanying drawings, it is to be understood that the invention is not limited to this precise embodiment and the described modifications, and that various changes and further modifications may be effected therein by one skilled in the art without departing from the scope or spirit of the invention as defined in the appended claims.

What is claimed is:

1. A method for communicating image data between a first cell phone and a remote processor, comprising:
capturing image data using a first cell phone camera;
connecting with the remote processor; and
synchronizing images stored in the first cell phone with images stored in a data storage device coupled to the remote processor.

2. The method of claim 1, wherein the synchronizing of images is performed automatically without an explicit user request.

3. The method of claim 1, wherein the remote processor comprises a second cell phone.

4. The method of claim 1, wherein the remote processor comprises a server.

5. The method of claim 1, comprising communicating over one of: a cellular protocol, an 802.11 protocol, a Bluetooth protocol.

6. The method of claim 1, comprising communicating a wireless local area network (WLAN) protocol.

7. The method of claim 6, comprising synchronizing image data only when excess WLAN bandwidth is available.

8. The method of claim 6, wherein the WLAN has a maximum upload bandwidth, comprising:
determining current data transmission utilization of the WLAN; and
synchronizing image data only when the current data transmission utilization of the WLAN is below the maximum upload bandwidth of the WLAN.

9. The method of claim 1, comprising printing the image data.

10. The method of claim 1, comprising archiving the image data.

11. A system for communicating image data between a first cell phone and a remote processor, comprising:
means for capturing image data using a first cell phone camera;
means for connecting with the remote processor; and
means for synchronizing images stored in the first cell phone with images stored in a data storage device coupled to the remote processor.

12. The system of claim 11, wherein the means for synchronizing of images automatically executes without an explicit user request.

13. The system of claim 11, wherein the remote processor comprises a second cell phone.

14. The system of claim 11, wherein the remote processor comprises a server.

15. The system of claim 11, comprising means for communicating over one of: a cellular protocol, an 802.11 protocol, a Bluetooth protocol.

16. The system of claim 11, comprising means for communicating a wireless local area network (WLAN) protocol.

17. The system of claim 16, comprising means for synchronizing image data only when excess WLAN bandwidth is available.

18. The system of claim 16, wherein the WLAN has a maximum upload bandwidth, comprising:
means for determining current data transmission utilization of the WLAN; and
means for synchronizing image data only when the current data transmission utilization of the WLAN is below the maximum upload bandwidth of the WLAN.

19. The system of claim 11, comprising means for printing the image data.

20. The system of claim 11, comprising means for archiving the image data.
